(19) United States
(12) Patent Application Publication
(10) Pub. No.: US 2025/0080974 A1
(43) Pub. Date: Mar. 6, 2025

(54) METHOD FOR REPORTING UE CAPABILITY, AND DEVICES

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN); Jiangsheng FAN, Dongguan (CN)

(21) Appl. No.: 18/948,602

(22) Filed: Nov. 15, 2024

Related U.S. Application Data
(63) Continuation of application No. PCT/CN2022/094189, filed on May 20, 2022.

(51) Int. Cl. H04W 8/24; H04W 72/04

(52) U.S. Cl. CPC H04W 8/24; H04W 72/04

(57) ABSTRACT

Provided is a method for reporting a user equipment (UE) capability. The method includes: reporting the UE capability to a network device in a case that a reporting condition is satisfied. The method is applicable to a terminal. The terminal includes a processor; a transceiver, communicably connected to the processor; and a memory, configured to store one or more executable instructions of the processor; wherein the processor is configured to load and execute the one or more executable instructions, to cause the terminal to perform the method.

### CROSS-REFERENCE TO RELATED APPLICATION

This application is a continuation application of international application No. PCT/CN2022/094189, filed on May 20, 2022, the entire contents of which are incorporated herein by reference.

### TECHNICAL FIELD

The present disclosure relates to the field of communications, and in particular, relates to methods and apparatuses for reporting a user equipment (UE) capability, and devices and a medium thereof.

### RELATED ART

In cellular network communication, accurate and efficient coordination and intercommunication between a network device and a UE are very important. The UE capability is an important part for the coordination between the network device and the UE.

### SUMMARY

Embodiments of the present disclosure provide a method for reporting a UE capability, and devices. The technical solutions are as follows.

According to some embodiments of the present disclosure, a method for reporting a UE capability is provided. The method includes: reporting the UE capability to a network device in a case that a reporting condition is satisfied.

According to some embodiments of the present disclosure, a terminal is provided. The terminal includes: a processor; a transceiver communicably connected to the processor; and a memory, configured to store one or more executable instructions of the processor. The processor, when loading and executing the one or more executable instructions, causes the terminal to perform the method for reporting the UE capability as described in the above aspect.

According to some embodiments of the present disclosure, a network device is provided. The network device includes: a processor; a transceiver communicably connected to the processor; and a memory, configured to store one or more executable instructions of the processor. The processor, when loading and executing the one or more executable instructions, causes the network device to perform: receiving the UE capability reported by a terminal, wherein the UE capability is reported by the terminal in a case that a reporting condition is satisfied.

### BRIEF DESCRIPTION OF DRAWINGS

For clearer descriptions of the technical solutions according to the embodiments of the present disclosure, the accompanying drawings required for describing the embodiments are briefly introduced hereinafter. It is obvious that the accompanying drawings in the following description show merely some the embodiments of the present disclosure, and a person of ordinary skill in the art may still derive other drawings from these accompanying drawings without creative efforts.

FIG. 1 illustrates a flow schematic diagram of reporting a UE capability in the related art;

FIG. 2 illustrates a structural schematic diagram of a neural network in the related art;

FIG. 3 illustrates a flowchart of a method for reporting a UE capability according to some embodiments of the present disclosure;

FIG. 4 illustrates a flowchart of a method for reporting a UE capability according to some embodiments of the present disclosure;

FIG. 5 illustrates a flowchart of a method for reporting a UE capability according to some embodiments of the present disclosure;

FIG. 6 illustrates a flowchart of a method for reporting a UE capability according to some embodiments of the present disclosure;

FIG. 7 illustrates a flowchart of a method for reporting a UE capability according to some embodiments of the present disclosure;

FIG. 8 illustrates a structural block diagram of an apparatus for reporting a UE capability according to some embodiments of the present disclosure;

FIG. 9 illustrates a structural block diagram of an apparatus for reporting a UE capability according to some embodiments of the present disclosure; and

FIG. 10 illustrates a structural schematic diagram of a communication device for reporting a UE capability according to some embodiments of the present disclosure.

### DETAILED DESCRIPTION

For clearer descriptions of the objectives, technical solutions and advantages of the present disclosure, embodiments of the present disclosure are further described in detail hereinafter with reference to the accompanying drawings. Exemplary embodiments are described in detail herein, examples of the embodiments are illustrated in the accompanying drawings. When the following description relates to the accompanying drawings, the same numerals in the different accompanying drawings indicate the same or similar elements unless otherwise indicated. The embodiments described in the following exemplary embodiments do not represent all embodiments consistent with the present disclosure. Instead, they are only examples of apparatuses and methods that are described in detail in the appended claims and consistent with some aspects of the present disclosure.

The terms used in the present disclosure are only for the purpose of describing specific embodiments and are not intended to limit the present disclosure. The articles “a,” “an,” and “the” used in the present disclosure and the appended claims are also intended to include the plural form, unless the context clearly indicates different meanings. It should also be understood that the phrase “and/or” herein refers to and includes any or all possible combinations of one or more of the associated listed items.

It should be understood that although the terms “first,” “second,” “third,” and the like are used in the present disclosure to describe various pieces of information, such information should not be limited to these terms. These terms are used only to distinguish the same type of information from one another. For example, without departing from the scope of the present disclosure, the first information may also be referred to the second information, and similarly, the second information may be referred to the first information. Depending on the context, the phrase “in a case that” herein may be interpreted as “in the case that,” “in the case of,” “when,” “upon,” or “in response to determining”.

First, the relevant technical background involved in the embodiments of the present disclosure is described.

### UE Capability Report

The cellular wireless communication system relies on accurate and efficient coordination and intercommunication between a network device, such as a base station, and a UE. The UE capability is critical to the coordination between the base station and the UE.

The base station is capable of correctly scheduling the UE under the premise of knowing the UE capability. In the case that the UE supports a function, the base station may configure this function for the UE. In the case that the UE does not support a function, the base station fails to configure this function for the UE.

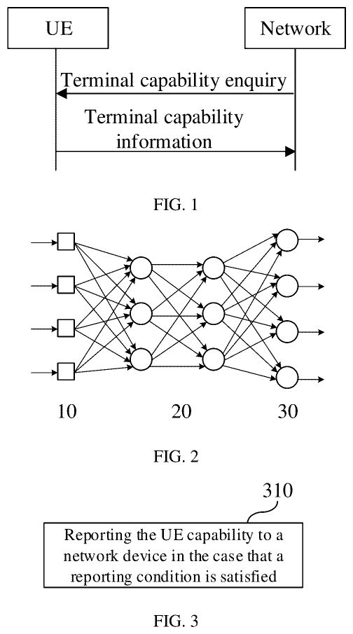

The UE capability reporting process in the related art is shown in FIG. 1.

Condition for triggering UE capability reporting: this process is triggered in the case that the UE enters the radio resource control (RRC) connection state, and a next-generation node base station (gNB) does not acquire the capability information of the UE from the core network (CN), or the gNB desires to acquire the latest UE capability information.

Process for UE capability reporting: the gNB triggers this process to request the UE to report capability information, the UE reports its own capability information to the gNB, and the gNB receives the UE capability information and forwards the UE capability information to the CN for storage.

Variation of UE capability information: in the case that the UE changes its capability information, the UE triggers a non-access stratum (NAS) procedure to update the UE capability information. In a long-term evolution (LTE) system, a variation of UE capability information triggers an attach procedure or a tracking area update procedure. In a 5^{th} generation (5G) mobile communication technology system, the UE capability information varies during the registration process.

### Integration of Artificial Intelligence (AI) and Communication Networks

In recent years, the research of AI and its related outcomes have achieved significant effects in many fields. AI now becomes a new path for people to try to solve and deal with problems. Among the researches, neural network-based AI research is extremely important. As shown in FIG. 2, a simple neural network basically includes an input layer (10), a hidden layer (20) and an output layer (30), wherein the input layer receives data, the hidden layer processes the data, and the output layer generates final results.

The combination of AI and wireless communication systems is a mainstream technique at present to optimize the system performance using AI functions. In the latest 3^{rd} Generation Partnership Project (3GPP) R18 project, it is also agreed to consider using AI to optimize the relevant use cases, including positioning, beam management (BM), channel state information (CSI) and the like. Models for different use cases may be deployed/inferred/trained on the network side or on the terminal side.

Training/inferring AI models imposes corresponding requirements on computing capabilities and storage capabilities. In the case that AI models are trained or inferred on the terminal side, some requirements are imposed on the UE capability. The present capability reporting of the 3GPP mainly focuses on functional capability reporting, such as whether the UE supports a specific feature. However, for AI-enabled use cases, in addition to whether the UE supports the feature, the capabilities such as computing power and storage of the UE also need to be reported to the network side.

From the terminal perspective of the terminal, the current service or operation of the UE directly affects the current available/remaining computing power/storage capability of the UE. For example, the requirements and use of computing power and storage are different when users play games or watch movies on mobile phones, and the remaining available computing power varies in real time with the current service type of the UE. For this dynamically varied capability reporting, how to instruct the network side is a problem to be solved.

In the related art, the network device transmits a UE capability enquiry to the UE, and the UE transmits UE capability information to the network device. However, this reporting mode cannot meet the reporting requirements in some scenarios.

FIG. 3 illustrates a flowchart of a method for reporting a UE capability according to some embodiments of the present disclosure. Description is given in the embodiments based on an example in which the method is applicable to a UE. The method includes at least some of the following processes.

In 310, the UE capability is reported to a network device in the case that a reporting condition is satisfied.

The “UE capability” in the embodiment includes a dynamically varied UE capability. In the case that the reporting condition is satisfied, the UE reports the dynamically varied UE capability to the network device. In some embodiments, the UE capability includes a UE capability that varies dynamically with at least one of a processor load, a remaining storage capability of a memory, a communication bandwidth capability, or a battery level.

In the case that the UE capability is an AI-related UE capability, for example, the UE reports the AI-related UE capability to the network device in the case that the reporting condition is satisfied. In some embodiments, the UE capability includes at least one of: a total capability, such as whether the UE supporting the AI function; a supported AI function-based use case; a supported AI category level; a computing capability; a storage capability; a communication capability; a battery level; or an AI model index.

Among the UE capabilities, a total capability, a AI function-based use case, a supported AI category level, and the like are referred to as functional capabilities; and a computing capability, a storage capability, a communication capability, a battery level, and the like are referred to as terminal hardware capabilities.

The AI function-based use case refers to a communication use case that is optimized based on the AI model. In some embodiments, the AI function-based use case includes at least one of AI-based positioning, AI-based beam management, AI-based channel state, user plane function information reporting in the air interface resources, or control plane function information reporting in air interface resources. For example, the supported AI function-based use case refers to supporting at least one of the AI-based positioning, the AI-based beam management, or the AI-based channel state information reporting. Alternatively, the supported AI function-based use case is at least one of all functions included in the user plane and the control plane in the air interface resources, e.g., at least one of handover, cell selection/reselection, measurement, random access process, or resource allocation.

The supported AI category level refers to a supported AI function category based on the AI model. In some embodiments, the AI category level includes at least one of whether to support training, inference, or data collection on the terminal side. For example, the supported AI category level includes at least one of whether the UE supports training of the AI model on the terminal side, whether the UE supports inference of the AI model on the terminal side, or whether the UE supports data collection of the AI model on the terminal side.

The computing capability, also referred to as computing power, refers to the computing capability of the UE in running program tasks. In some embodiments, the computing capability is represented by at least one of a floating point computing capability per unit time, the number of graphics processing units (GPUs), or a GPU cache size. In some embodiments, the computing capability is categorized into a total computing capability and an AI computing capability. The total computing capability, i.e., the total computing power, refers to the overall computing capability of the UE. The AI computing capability refers to the computing capability of the UE to run the AI model, which may reflect the complexity of the AI model supported by the UE. In some embodiments, the AI computing capability is the computing capability of the UE to run the AI model, or the computing capability of the total computing capability of the UE that is maximally allocated or is currently allowed to be allocated to run the AI model, or the remaining computing capability of the total computing capability of the UE other than the computing capability to compute the non-AI model that is running, or the remaining computing capability of the maximum amount of computing capability of the UE that is allocated to run the AI model other than the computing capability that has been used and/or reserved.

The storage capability is a capacity of the UE to store data. In some embodiments, the storage capability is represented by at least one of an available memory size, an available cache size, or an available storage size. In some embodiments, the storage capability is categorized into a total storage capability and an AI storage capability. The total storage capability refers to the storage capability of the UE to store all the data. The AI storage capability refers to the storage capability of the UE to store and/or run the AI model. In some embodiments, the AI storage capability is the storage capability provided by the UE to store and/or run the AI model, or the storage capability of the total storage capability of the UE that is maximally allocated or currently allowed to be allocated to store and/or run the AI model, or the remaining storage capability of the total storage capability of the UE other than the storage capability to store the non-AI model that is running, or the remaining storage capability of the maximum amount of storage capability of the UE that is allocated to store the AI model other than the storage capability that has been used and/or reserved. Schematically, the AI storage capability is further categorized into a static storage capability, such as a flash memory capability, to store the AI model and data related to the AI model; and a dynamic storage capability, such as a memory capability, to store running data of the AI model.

The communication capability, also referred to as transmission capability, is the capability of the UE to communicate or transmit data, including at least one of bandwidth, rate, or delay. In some embodiments, the communication capability is represented by at least one of a supportable transmission rate, a transmission delay, a communication signal strength, channel quality state information, a transmission bit error rate, a transmission misinformation block rate, or a spectrum efficiency. In some embodiments, the communication capability is categorized into a total communication capability and an AI communication capability. The total communication capability refers to the overall communication capability of the UE. The AI communication capability refers to the capability of the UE to transmit the AI model and/or related data of the AI model. The related data includes training samples, model architecture, model parameters, and the like. In some embodiments, the AI communication capability is the communication capability provided by the UE to transmit the AI model, or the communication capability of the total communication capability of the UE that is maximally allocated or currently allowed to be allocated to transmit the AI model, or the remaining communication capability of the total communication capability of the UE other than the capability that is currently used to transmit the non-AI model, or the remaining communication capability of the maximum amount of communication capability of the UE that is allocated to transmit the AI model other than the communication capability that has been used and/or reserved.

The battery level is the battery level of the UE, and is the battery level available for the AI model to run. In some embodiments, the battery level is represented by the remaining battery level. In some embodiments, the battery level is categorized into a total battery level and an AI battery level. The total battery level refers to the total battery level of the UE. The AI battery level refers to the battery level that is used by the UE to run the AI model. In some embodiments, the AI battery level is the battery level provided by the UE to store and/or run the AI model, or the battery level of the total battery level of the UE that is maximally allocated or is currently allowed to be allocated to run the AI model, or the remaining battery level of the total battery level of the UE other than the battery level that has been used or is to be used to run the non-AI model application, or the remaining battery level of the maximum amount of battery level of the UE that is allocated to run the AI model other than the battery level that has been used and/or reserved.

The AI model index, also referred to as an AI model identification, is for indicating the AI model. Schematically, the AI model index is for indicating an AI model selected by the UE or an AI model supported by the UE based on the current UE capability.

In some embodiments, prior to reporting the AI model index selected by the UE itself to the network device, the UE needs to acquire information of at least one AI model. The information of the AI model includes at least one of the AI model index, the use case corresponding to the AI model, the AI model size, the AI model accuracy, the AI model complexity, or the generalization capability of the AI model. In some embodiments, the information of the at least one AI model is predefined by a communication protocol, or transmitted by the network device to the UE over an RRC message, or transmitted by the network device to the UE over an NAS message, or transmitted by the network device to the UE over a system broadcast, or transmitted over the NAS layer in the UE to the access stratum (AS).

In some embodiments, the UE capability reporting further includes a granularity supported by the UE capability, such as per band, per terminal, per UE, different cases of frequency division duplex (FDD)/time division duplex (TDD) (FDD/TDD differ), and different cases of FR1/FR2 (FR1/FR2 differ). AI-related capability reporting is tied to the associated use case, e.g., the information element (IE) in the beam failure recovery (BFR) capability reporting includes the capability information for AI BFR, which includes at least one of support or non-support of AI-enabled BFR indicated by one binary digit (bit), and/or at least one of the functional capabilities described above, and/or at least one of the hardware capabilities described above.

In some embodiments, the UE capability reporting includes a variation of the current UE capability relative to the previously reported UE capability. Exemplarily, the variation of the UE capability includes at least one of:
a variation of the current AI computing capability relative to the previously reported AI computing capability;
a variation of the current AI storage capability relative to the previously reported AI storage capability;
a variation of the current AI communication capability relative to the previously reported AI communication capability;
a variation of the current AI battery level relative to the previously reported AI battery level;
a time difference between the current time relative to the previously reported time;
a distance between the current position relative to the previously reported position; or
a handover quantity of service cells between the current reporting environment and the previous reporting environment.

In some embodiments, the above variation is indicated using an explicit indication, or a bitmap indication, or a variation level.

In some embodiments, the UE capability reporting is reporting of the capability of each supported AI function use case, or the capability of a single AI function use case, or the total capability of the supported AI functions. The variation of the capability determined by the UE is a variation of the total capability of the AI functions, or a variation of the capability of a single AI function use case, or a variation of the capability of each AI function use case. That is, the granularity of the above UE capability reporting is at least one of: the granularity of a total capability, the granularity of a total AI capability, or the granularity of an AI capability of a single AI function use case. The determining granularity of the above UE capability variation is at least one of: the granularity of the total capability, the granularity of the total AI capability, or the granularity of the AI capability of the single AI function use case.

In some embodiments, the at least one capability in the reporting content is explicitly indicated, and/or the at least one capability is separately indicated using a capability level, and/or the at least two capabilities are indicated in combination using one capability level. In some embodiments, the capability level and/or the range corresponding to the capability level is predefined by the communication protocol or configured by the network device.

Exemplarily, the UE capability information is explicitly indicated in the UE capability reporting information, including at least one of: a category of the UE capability, a name of the UE capability, a parameter of the UE capability, or other information. For example, the battery level of the UE capability is explicitly indicated, and information of 3 bits in 8 modes is used to indicate the current battery level. The code point “000” represents a battery level ranging from 0 to 12.5%, the code point “001” represents a battery level ranging from 12.5 to 25%, and the code point “111” represents a battery level ranging from 87.5 to 100%, and the like.

Exemplarily, the UE capability reporting information uses a capability level to separately indicate the capability level of the current UE capability. For example, the UE capability reporting information indicates that the computing capability level is A, the storage capability level is B, and the communication capability level is C.

Exemplarily, the UE capability reporting information indicates the capability levels of the current UE capability in combination using one capability level. Exemplarily, the UE capability reporting information indicates that the current UE capability level is A, which indicates that the capability levels of computing capability, storage capability, communication capability, and battery level of the current UE are A. Alternatively, as shown in Table 1, a floating point computing capability of the current UE capability is not less than a1, an available storage size is not less than a2, a transmission rate is not less than a3, and a current battery level is not less than a4. The UE indicates the capability levels of the current UE capability in combination using the capability level A in the UE capability reporting information.

TABLE 1
Schematic table of UE capability levels indicated in combination

| UE | Single UE capability | | | | | | | |
|---|---|---|---|---|---|---|---|---|
| capability | Capability | Current | Capability | Current | Capability | Current | Capability | Current |
| level | category | capability | Category | Capability | Category | Capability | Category | Capability |
| A | Computing | Floating | Storage | Available | Communication | Transmission | Battery | Current |
| | capability | point | capability | storage | capability | rate not less | level | battery |
| | | computing | | size not | | than a3 | | level not |
| | | capability | | less than | | | | less than |
| | | not less | | a2 | | | | a4 |
| | | than a1 | | | | | | |
| B | Computing | Floating | Storage | Available | Communication | Transmission | Battery | Current |
| | capability | point | capability | storage | capability | rate not less | level | battery |
| | | computing | | size not | | than b3 | | level not |
| | | capability | | less than | | | | less than |
| | | not less | | b2 | | | | b4 |
| | | than b1 | | | | | | |
| C | Computing | Floating | Storage | Available | Communication | Transmission | Battery | Current |
| | capability | point | capability | storage | capability | rate not less | level | battery |
| | | computing | | size not | | than c3 | | level not |
| | | capability | | less than | | | | less than |
| | | not less | | c2 | | | | c4 |
| | | than c1 | | | | | | |

In some embodiments, the variation of the current UE capability in the reported content relative to the previously reported UE capability is explicitly indicated, and/or the variation of the at least one of the capability is separately indicated using a capability variation level, and/or the variations of the at least two capabilities are indicated in combination using one capability variation level. In some embodiments, the capability variation level and/or the range corresponding to the capability variation level is predefined by the communication protocol or configured by the network device.

Exemplarily, the UE capability reporting information explicitly indicates the variation of the current UE capability relative to the previously reported UE capability, including at least one of a category of the UE capability, a name of the UE capability, a variation of a parameter of the UE capability, or other information. For example, in the UE capability reporting information, an AI storage capability reduction X is used to explicitly indicate the variation of the current AI storage capability relative to the previously reported AI storage capability.

Exemplarily, the UE capability reporting information uses a capability variation level to separately indicate the variation of the current UE capability relative to the previously reported UE capability. For example, the UE capability reporting information indicates that the variation level of the AI computing capability is A, the variation level of the AI storage capability is B, and the variation level of the AI communication capability is C.

Exemplarily, the UE capability reporting information uses the capability variation level to indicate the variation of the current UE capability relative to the previously reported UE capability in combination. Exemplarily, the variation of the current UE computing capability is within the capability variation range d1, the variation of the battery level is within the capability variation range d2, the variation of the communication capability is within the capability variation range d3, the variation of the storage capability is within the capability variation range d4, and the UE uses the capability variation level D in the UE capability reporting information to indicate the capability variation levels of the current UE capability in combination.

In some embodiments, the UE capability is carried in a radio resource control (RRC) message, a medium access control (MAC) control element (CE) message, or an uplink control information (UCI) message for reporting. In some embodiments, the RRC message, the MAC CE message or the UCI message indicates a variation of the UE capability.

In some embodiments, the UE reports the variation of the UE capability over the RRC message, and uses UE assistance information (UAI) signaling for transmission. Exemplarily, the UE is triggered to report the UE capability using the UAI reporting process in the case that at least one of the above reporting conditions is satisfied.

In some embodiments, in the case that the UE capability satisfies the first condition, and/or in the case that a variation of the current reporting environment relative to the reporting environment of the previous reporting satisfies the second condition, the UE capability is reported to the network device.

In some embodiments, the UE reports the UE capability to the network device based on the configuration of the network device.

In some embodiments, the UE reports the UE capability to the network device at initial access.

In some embodiments, the UE receives configuration information from the network device. The configuration information is for configuring the reporting resource of the UE capability. In some embodiments, the UE reports the UE capability based on the reporting resource configured by the network device.

In some embodiments, the UE reports a supported AI model index to the network device.

In some embodiments, the UE autonomously switches to the AI model corresponding to the UE capability based on the current UE capability, or the UE switches to the AI model corresponding to the UE capability based on the configuration of the network device.

In some embodiments, the UE has at least two AI models, or indexes of at least two AI models, or parameters of at least two AI models. Based on the handover rule, the UE autonomously switches to the AI model corresponding to the UE capability. In some embodiments, the handover rule is predefined by a communication protocol, or configured by a network device, or autonomously determined by the UE. In some embodiments, the at least two AI models, or the indexes of the at least two AI models, or the parameters of the at least two AI models are locally stored by the UE or configured by the network device.

In some embodiments, the UE has at least two AI models, or indexes of the at least two AI models, or parameters of the at least two AI models. Based on the configuration of the network device, the UE switches to the AI model corresponding to the UE capability. In some embodiments, the at least two AI models or the indexes of the at least two AI models or the parameters of the at least two AI models are locally stored by the UE or configured by the network device.

In summary, in the method according to the embodiments of the present disclosure, by reporting the UE capability to the network device based on the dynamic variation of the UE capability, the network device is semi-statically instructed, and thus the autonomy, accuracy and flexibility of the UE capability reporting are improved. The method may be reasonably used to report/update the dynamically varied UE capability to a network device in the case that the UE capability is dynamically varied.

In the present disclosure, the cases satisfying the reporting condition are categorized into at least three types:
Type I: the UE capability satisfies the first condition.
Type II: the variation of the current reporting environment relative to the reporting environment of the previous reporting satisfies the second condition.
Type III: based on the reporting mode configured by the network device.

### Type I: The UE Capability Satisfies the First Condition

In the case that the UE capability satisfies the first condition, the UE capability is reported to the network device. In some embodiments, the first condition is predefined, preconfigured, or configured by the network device.

In some embodiments, the UE capability is reported to the network device in the case that a variation of the UE capability satisfies the first condition.

In some embodiments, the UE capability is reported to the network device in the case that the variation of at least one capability of the UE capability satisfies the first condition. In some embodiments, the at least one capability is predefined, preconfigured, or configured by the network device.

In some embodiments, satisfying the first condition includes at least one of the following items:
the UE capability is less than a first threshold;
the UE capability is greater than a second threshold; or
a variation of the UE capability relative to the previously reported UE capability is greater than a third threshold.

In some embodiments, the first threshold is a minimum UE capability that ensures the running of the AI model.

In some embodiments, the first threshold is a minimum computing capability to ensure the running of the AI model. In the case that the current computing capability of the UE is less than the first threshold, the UE reports the UE capability to the network device.

In some embodiments, the first threshold is a minimum storage capability to ensure the running of the AI model. In the case that the current storage capability of the UE is less than the first threshold, the UE reports the UE capability to the network device.

In some embodiments, the first threshold is a minimum communication capability to ensure the running of the AI model. In the case that the current communication capability of the UE is less than the first threshold, the UE reports the UE capability to the network device.

In some embodiments, the first threshold is a minimum battery level to ensure the running of the AI model. In the case that the current battery level of the UE is less than the first threshold, the UE reports the UE capability to the network device.

In some embodiments, the second threshold is a UE capability requirement corresponding to an AI model with different performance, i.e., a different threshold (range).

In some embodiments, the second threshold is a different computing capability requirement corresponding to an AI model with different performance. In the case that the available computing capability of the UE rises to be greater than the second threshold, or falls to be less than the second threshold, the UE reports the UE capability to the network device, such that the network device updates the corresponding AI model.

In some embodiments, the second threshold is a different storage capability requirement corresponding to an AI model with different performance. In the case that the available storage capability of the UE rises to be greater than the second threshold, or falls to be less than the second threshold, the UE reports the UE capability to the network device, such that the network device updates the corresponding AI model.

In some embodiments, the second threshold is a different communication capability requirement corresponding to an AI model with different performance. In the case that the available communication capability of the UE rises to be greater than the second threshold, or falls to be less than the second threshold, the UE reports the UE capability to the network device, such that the network device updates the corresponding AI model.

In some embodiments, the second threshold is a different battery level requirement corresponding to an AI model with different performance. In the case that the available battery level of the UE rises to be greater than the second threshold, or falls to be less than the second threshold, the UE reports the UE capability to the network device, such that the network device updates the corresponding AI model.

In some embodiments, the third threshold is difference information of the variation of the UE capability, which is a variation indicating a single capability or a variation indicating a plurality of capabilities.

In some embodiments, the third threshold is a variation between the current available computing capability of the UE and the previously reported available computing capability. In the case that the variation of the current available computing capability of the UE relative to the previously reported available computing capability is greater than the third threshold, the UE reports the UE capability to the network device, such that the network device updates the corresponding AI model or configuration.

In some embodiments, the third threshold is a variation between the current available storage capability of the UE and the previously reported available storage capability. In the case that the variation of the current available storage capability of the UE relative to the previously reported available storage capability is greater than the third threshold, the UE reports the UE capability to the network device, such that the network device updates the corresponding AI model or configuration.

In some embodiments, the third threshold is a variation between the current available communication capability of the UE and the previously reported available communication capability. In the case that the variation of the current available communication capability of the UE relative to the previously reported available communication capability is greater than the third threshold, the UE reports the UE capability to the network device, such that the network device updates the corresponding AI model or configuration.

In some embodiments, the third threshold is a variation between the current available battery level of the UE and the previously reported available battery level. In the case that the variation of the current available battery level of the UE relative to the previously reported available battery level is greater than the third threshold, the UE reports the UE capability to the network device, such that the network device updates the corresponding AI model or configuration.

In some embodiments, the range of the first threshold is the same as the range of the second threshold, or the range of the first threshold is overlapped with the range of the second threshold, or the range of the first threshold is different from the range of the second threshold.

### Type II: The Variation of the Current Reporting Environment Relative to the Reporting Environment of the Previous Reporting Satisfies the Second Condition

The UE capability is reported to the network device in the case that the variation of the current reporting environment relative to the reporting environment of the previous reporting satisfies the second condition. In some embodiments, the second condition is predefined, preconfigured, or configured by the network device.

In some embodiments, the variation of the current reporting environment relative to the reporting environment of the previous reporting satisfying the second condition includes at least one of the following items:
a duration between a current time and a time of the previous reporting is greater than a fourth threshold; or
a distance between a current position and a position of the previous reporting is greater than a fifth threshold.

In some embodiments, the fourth threshold is a time difference threshold (range) between the current time and the time of the previous reporting. In the case that the difference between the current time and the time of previous UE capability reporting is greater than the fourth threshold, the UE reports the UE capability again. Exemplarily, the fourth threshold is 30 minutes, and the UE reports the UE capability to the network device in the case that the duration between the current time and the time of the previous reporting is greater than 30 minutes.

In some embodiments, the fifth threshold is a distance threshold (range) or a region threshold (range). In some embodiments, the fifth threshold is a distance threshold. In the case that the distance between current position and the position of the previous reporting is greater than the fifth threshold, the UE reports the UE capability to the network device, such that the network device updates the corresponding AI model or configuration. Exemplarily, the fifth threshold is 200 meters, and the UE reports the UE capability to the network device in the case that the distance between the current position and the position of the previous reporting is greater than 200 meters. In some embodiments, the fifth threshold is a region threshold, such as at least one cell, and the UE reports the UE capability to the network device in the case that the distance between the current position and the position of the previous reporting is greater than the fifth threshold, such that the network device updates the corresponding AI model or configuration. Exemplarily, the fifth threshold is one cell, and the UE reports the UE capability to the network device in the case that the current position is beyond the range of cell in which the position of the previous reporting is located.

In some embodiments, the UE capability reported by the UE to the network device includes at least one of: a total capability, e.g., whether the UE supports the AI function; a supported AI function-based use case; a supported AI category level; a computing capability; a storage capability; a communication capability; battery level; or an AI model index.

Among the above UE capabilities, a total capability, a AI function-based use case, and a supported AI category level are referred to as functional capabilities; and a computing capability, a storage capability, a communication capability, and a battery level are referred to as terminal hardware capabilities.

The AI function-based use case refers to a communication use case that is optimized based on the AI model. In some embodiments, the AI function-based use case includes at least one of AI-based positioning, AI-based beam management, AI-based channel state, user plane function information reporting in the air interface resources, or control plane function information reporting in the air interface resources. For example, the supported the AI function-based use case refers to supporting at least one of the AI-based positioning, the AI-based beam management, or the AI-based channel state information reporting. Alternatively, the supported AI function-based use case is at least one of all functions included in the user plane and the control plane in the air interface resources, e.g., at least one of: handover, cell selection/reselection, measurement, random access process, or resource allocation.

The supported AI category level refers to a supported AI function category based on the AI model. In some embodiments, the AI category level includes at least one of whether to support training, inference, or data collection on the terminal side. For example, the supported AI category level includes at least one of whether the UE supports training of the AI model on the terminal side, whether the UE supports inference of the AI model on the terminal side, or whether the UE supports data collection of the AI model on the terminal side.

The computing capability, also referred to as computing power, refers to the computing capability of the UE in running program tasks. In some embodiments, the computing capability is represented by at least one of a floating point computing capability per unit time, the number of GPUs, or a GPU cache size. In some embodiments, the computing capability is categorized into a total computing capability and an AI computing capability. The total computing capability, i.e., the total computing power, refers to the overall computing capability of the UE. The AI computing capability refers to the computing capability of the UE to run the AI model, which may reflect the complexity of the AI model supported by the UE. In some embodiments, the AI computing capability is the computing capability provided by UE to run the AI model, or the computing capability of the total computing capability of the UE that is maximally allocated or is currently allowed to be allocated to run the AI model, or the remaining computing capability of the total computing capability of the UE other than the computing capability to compute the non-AI model that is running, or the remaining computing capability of the maximum amount of computing capability of the UE that is allocated to run the AI model other than the computing capability that has been used and/or reserved.

The storage capability is a capacity of the UE to store data. In some embodiments, the storage capability is represented by at least one of an available memory size, an available cache size, or an available storage size. In some embodiments, the storage capability is categorized into a total storage capability and an AI storage capability. The total storage capability refers to the storage capability of the UE to store all the data. The AI storage capability refers to the storage capability of the UE to store and/or run the AI model. In some embodiments, the AI storage capability is the storage capability provided by the UE to store and/or run the AI model, or the storage capability of the total storage capability of the UE that is maximally allocated or currently allowed to be allocated to store and/or run the AI model, or the remaining storage capability of the total storage capability of the UE other than the storage capability to store the non-AI model that is running, or the remaining storage capability of the maximum amount of storage capability of the UE that is allocated to store the AI model other than the storage capability that has been used and/or reserved. Schematically, the AI storage capability is further categorized into a static storage capability, such as a flash memory capability, to store the AI model and data related to the AI model; and a dynamic storage capability, such as a memory capability, to store running data of the AI model.

The communication capability, also referred to as transmission capability, is the capability of the UE to communicate or transmit data, including at least one of bandwidth, rate, or delay. In some embodiments, the communication capability is represented by at least one of a supportable transmission rate, a transmission delay, a communication signal strength, channel quality state information, a transmission bit error rate, a transmission misinformation block rate, or a spectrum efficiency. In some embodiments, the communication capability is categorized into a total communication capability and an AI communication capability. The total communication capability refers to the overall communication capability of the UE. The AI communication capability refers to the capability of the UE to transmit the AI model and/or related data of the AI model. The related data includes training samples, model architecture, model parameters, and the like. In some embodiments, the AI communication capability is the communication capability provided by the UE to transmit the AI model, or the communication capability of the total communication capability of the UE that is maximally allocated or currently allowed to be allocated to transmit the AI model, or the remaining communication capability of the total communication capability of the UE other than the communication capability that is currently used to transmit the non-AI model, or the remaining communication capability of the maximum amount of communication capability of the UE that is allocated to transmit the AI model other than the communication capability that has been used and/or reserved.

The battery level is the battery level of the UE, and is the battery level available for the AI model to run. In some embodiments, the battery level is represented by the remaining battery level. In some embodiments, the battery level is categorized into a total battery level and an AI battery level. The total battery level refers to the total battery level of the UE. The AI battery level refers to the battery level of the UE to run the AI model. In some embodiments, the AI battery level is the battery level of the UE to run the AI model, or the battery level of the total battery level of the UE that is maximally allocated or is currently allowed to be allocated to run the AI model, or the remaining battery level of the total battery level of the UE other than the battery level that has been used or is to be used to run the non-AI model application, or the remaining battery level of the maximum amount of battery level of the UE that is allocated to run the AI model other than the battery level that has been used and/or reserved.

The AI model index, also referred to as an AI model identification, is for indicating the AI model. Schematically, the AI model index is for indicating an AI model selected by the UE or an AI model supported by the UE based on the current UE capability.

In some embodiments, prior to reporting the AI model index selected by the UE itself to the network device, the UE needs to acquire information of at least one AI model. The information of the AI model includes at least one of: the AI model index, the use case corresponding to the AI model, the AI model size, the AI model accuracy, the AI model complexity, or the generalization capability of the AI model. In some embodiments, the information of the at least one AI model is predefined by a communication protocol, or transmitted by the network device to the UE over an RRC message, or transmitted by the network device to the UE over an NAS layer message, or transmitted by the network device to the UE over a system broadcast, or transmitted over the NAS layer in the UE to the AS.

In some embodiments, the UE capability reporting further includes a granularity supported by the UE capability, such as per band, per terminal, per UE, different cases of FDD/TDD, and different cases of FR1/FR2. AI-related capability reporting is tied to the associated use case, e.g., the IE in the BFR capability reporting includes the capability information for AI BFR, which includes at least one of support or non-support of AI-enabled BFR indicated by one bit, and/or at least one of the functional capabilities described above, and/or at least one of the hardware capabilities described above.

In some embodiments, the UE reports the selected or supported AI model index. In some embodiments, the AI model index is an AI model index supported by the current UE capability, or an AI model index selected by the UE based on the current UE capability. The network device configures the first model set for the UE upon receiving the UE capability reported by the UE. The UE capability includes a static capability and a dynamic capability, wherein the static capability refers to a capability of the UE that does not vary dynamically, such as a battery capacity, a storage specification, a CPU performance, and the like. The dynamic capability refers to a capability of the UE that varies dynamically, including a UE capability that varies dynamically with at least one of: a load of a processor, a remaining storage capability of a memory, a communication bandwidth capability, or a battery level. The first model set includes N AI models, and the N AI models all match the static capability of the UE. The network device determines the first model set that can be used by the UE based on the received static capability. Further, the network device or the UE determines, based on the dynamic capabilities of the UE, an AI model that the is currently used or supported by UE among the N AI models. Further, in the case that the UE determines the currently supported AI model among the N AI models based on the dynamic capability of the UE, the UE also reports the AI model index supported by the current UE capability to the network device, such that the network device switches to the AI model corresponding to the AI model index. Alternatively, in the case that the network device determines the AI model currently supported by the UE among the N AI models based on the dynamic capability, the network device configures the AI model index supported by the current UE capability for the UE, such that the UE switches to the AI model corresponding to the AI model index.

Exemplarily, the N AI models in the first model set configured by the network device for the UE are associated with different levels of UE capability, such as different levels of computing capability, different levels of storage capability, different levels of battery level, different levels of communication capability, and the like. The UE uses the AI model-based BM function, and in the case that the battery level decreases, the UE autonomously switches to the AI model that matches the current battery level and reports the currently supported AI model index to the network device. Alternatively, the UE uses the AI model-based BM function, and the UE reports the UE capability to the network device in the case that the above reporting conditions are satisfied. The network device determines the AI model currently supported by the UE based on the current UE capability, and configures an index of the AI model for the UE, such that the UE switches to the corresponding AI model based on the AI model index configured by the network device.

In some embodiments, the UE capability reporting includes a reporting time. In some embodiments, the reporting time includes a current time, and/or a serial number of the frame structure in which the current time is located. In some embodiments, the UE capability reporting further includes a time difference between the current time and the time of the previous reporting.

In some embodiments, the UE capability reporting includes a reporting position. In some embodiments, the reporting position includes an absolute position and/or a relative position. The absolute position is a latitude and longitude position where the UE is currently located. The relative position is an offset value of the current position of the UE relative to the position of the previous reporting or a reference position. In some embodiments, the reference position is predefined by a communication protocol, or configured by a network device, or determined autonomously by the UE. Exemplarily, the reference position is a position of a base station. In some embodiments, the UE capability reporting further includes a distance between the current position and the position of the previous reporting.

In some embodiments, the UE capability reporting includes a cell identifier of a service cell and/or a handover quantity of service cells. The cell identifier of the service cell is for indicating the service cell currently used by the UE to the network device, and the handover quantity of the service cells is for indicating the quantity of switching the service cells by the UE between the current reporting environment and the previous reporting environment to the network device. Exemplarily, the UE capability reporting includes information indicating that the current service cell of the UE is the cell A. Exemplarily, the UE capability reporting includes information indicating that the UE switches the service cells for two times between the current time and the time of the previous reporting.

In some embodiments, the UE capability reporting includes a variation of the current UE capability relative to the previously reported UE capability. Exemplarily, the variation of the UE capability includes at least one of:
a variation of the current AI computing capability relative to the previously reported AI computing capability;
a variation of the current AI storage capability relative to the previously reported AI storage capability;
a variation of the current AI communication capability relative to the previously reported AI communication capability;
a variation of the current AI battery level relative to the previously reported AI battery level;
a time difference between the current time relative to the previously reported time;
a distance between the current position relative to the previously reported position; or
a handover quantity of service cells between the current reporting environment and the previous reporting environment.

In some embodiments, the above variation is indicated using an explicit indication, or a bitmap indication, or a variation level.

In some embodiments, the UE capability reporting is reporting of the capability of each supported AI function use case, or the capability of a single AI function use case, or the total capability of the supported AI functions. The variation of the capability determined by the UE is a variation of the total capability of the AI functions, or a variation of the capability of a single AI function use case, or a variation of the capability of each AI function use case. That is, the granularity of the above UE capability reporting is at least one of: the granularity of a total capability, the granularity of a total AI capability, or the granularity of an AI capability of a single AI function use case. The determining granularity of the above UE capability variation is at least one of: the granularity of the total capability, the granularity of the total AI capability, or the granularity of the AI capability of the single AI function use case. In some embodiments, the at least one capability in the reporting content is explicitly indicated, and/or the at least one capability is separately indicated using a capability level, and/or the at least two capabilities are indicated in combination using one capability level. In some embodiments, the capability level and/or the range corresponding to the capability level is predefined by the communication protocol or configured by the network device.

In some embodiments, the variation of the current UE capability in the reported content relative to the previously reported UE capability is explicitly indicated, and/or the variation of the at least one of the capabilities is separately indicated using a capability variation level, and/or the variations of the at least two capabilities are indicated in combination using one capability variation level. In some embodiments, the capability variation level and/or the range corresponding to the capability variation level is predefined by the communication protocol or configured by the network device.

In some embodiments, at least one capability of the UE capability satisfies at least one of the above cases of type I or type II, or in the case that a plurality of capabilities satisfy at least one of type I or type II simultaneously, the UE reports the UE capability to the network device, such that the network device updates the corresponding AI model or configuration.

### Type III: Based on the Reporting Mode Configured by the Network Device

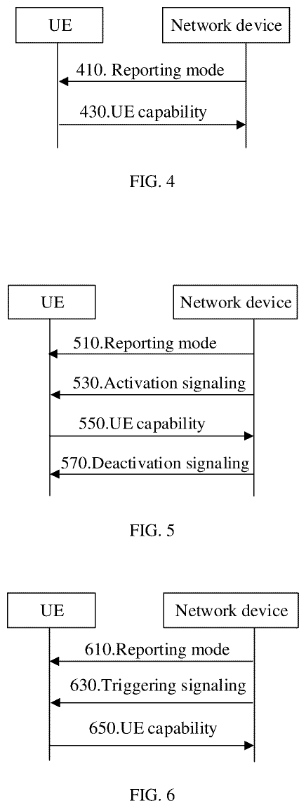

FIG. 4 illustrates a flowchart of a method for reporting the UE capability according to some embodiments of the present disclosure. Description is given in the embodiments based on an example in which the method is applicable to a UE. The method includes at least some of the following processes.

In 410, a reporting mode configured by the network device is received.

The reporting mode includes a periodicity for reporting the dynamically varied UE capability. The reporting mode configured by the network device includes at least one of: periodic reporting; semi-persistent reporting; or aperiodic reporting

In some embodiments, prior to performing the process 410, the UE transmits a capability update reporting indication information to the network device, the capability update reporting indication information is for notifying the network device that the UE desires to update its own capability information.

In some embodiments, the reporting mode is carried over the RRC message for transmission.

In 430, the UE capability is reported to the network device based on the reporting mode configured by the network device.

The UE reports the UE capability to the network device based on the reporting mode configured by the network device. In some embodiments, the UE capability is carried over the RRC message or the MAC CE message or the UCI message to be reported to the network device.

In some embodiments, the UE capability reported by the UE to the network device includes at least one of: a total capability, e.g., whether the UE supports the AI function; a supported AI function-based use case; a supported AI category level; a computing capability; a storage capability; a communication capability; a battery level; or an AI model index.

Among the above UE capability, the total capability, the use cases based on the AI function, and the supported AI category level are referred to as functional capabilities. The computing capability, storage capability, communication capability, and battery level are referred to as terminal hardware capabilities.

The AI function-based use case refers to a communication use case that is optimized based on the AI model. In some embodiments, the AI function-based use case includes at least one of AI-based positioning, AI-based beam management, AI-based channel state, user plane function information reporting in the air interface resources, and control plane function information reporting in the air interface resources. For example, the supported the AI function-based use case refers to supporting at least one of the AI-based positioning, the AI-based beam management, or the AI-based channel state information reporting. Alternatively, the supported AI function-based use case is at least one of all functions included in the user plane and the control plane in the air interface resource, e.g., at least one of: handover, cell selection/reselection, measurement, random access process, or resource allocation.

The supported AI category level refers to a supported AI function category based on the AI model. In some embodiments, the AI category level includes at least one of whether to support training, inference, or data collection on the terminal side. For example, the supported AI category level includes at least one of: whether the UE supports training of the AI model on the terminal side, whether the UE supports inference of the AI model on the terminal side, or whether the UE supports data collection of the AI model on the terminal side.

The computing capability, also referred to as computing power, refers to the computing capability of the UE in running program tasks. In some embodiments, the computing capability is represented by at least one of a floating point computing capability per unit time, the number of GPUs, or a GPU cache size. In some embodiments, the computing capability is categorized into a total computing capability and an AI computing capability. The total computing capability, i.e., the total computing power, refers to the overall computing capability of the UE. The AI computing capability refers to the computing capability of the UE to run the AI model, which may reflect the complexity of the AI model supported by the UE. In some embodiments, the AI computing capability is the computing capability of the UE ro eun the AI model, or the computing capability of the total computing capability of the UE that is maximally allocated or is currently allowed to be allocated to run the AI model, or the remaining computing capability of the total computing capability of the UE other than the computing capability used to compute the non-AI model that is running, or the remaining computing capability of the maximum amount of computing capability of the UE that is allocated to run the AI model other than the computing capability that has been used and/or reserved.

The storage capability is the capability of the UE to store data. In some embodiments, the storage capability is represented by at least one of an available memory size, an available cache size, or an available storage size. In some embodiments, the storage capability is categorized into a total storage capability and an AI storage capability. The total storage capability refers to the storage capability of the UE to store all the data. The AI storage capability refers to the storage capability of the UE to store and/or run the AI model. In some embodiments, the AI storage capability is the storage capability provided by the UE to store and/or run the AI model, or the storage capability of the total storage capability of the UE that is maximally allocated or currently allowed to be allocated to store and/or run the AI model, or the remaining storage capability of the total storage capability of the UE other than the storage capability used to store the non-AI model that is running, or the remaining storage capability of the maximum amount of storage capability of the UE that is allocated to store the AI model other than the storage capability that has been used and/or reserved. Schematically, the AI storage capability is further categorized into a static storage capability, such as a flash memory capability, to store the AI model and data related to the AI model; and a dynamic storage capability, such as a memory capability, to store running data of the AI model.

The communication capability, also referred to as transmission capability, is the capability of the UE to communicate or transmit data, including at least one of bandwidth, rate, or delay. In some embodiments, the communication capability is represented by at least one of a supportable transmission rate, a transmission delay, a communication signal strength, channel quality state information, a transmission bit error rate, a transmission misinformation block rate, or a spectrum efficiency. In some embodiments, the communication capability is categorized into a total communication capability and an AI communication capability. The total communication capability refers to the overall communication capability of the UE. The AI communication capability refers to the capability of the UE to transmit the AI model and/or related data of the AI model. The related data includes training samples, model architecture, model parameters, and the like. In some embodiments, the AI communication capability is the communication capability that the UE provided by the UE to transmit the AI model, or the communication capability of the total communication capability of the UE that is maximally allocated or currently allowed to be allocated to transmit the AI model, or the remaining communication capability of the total communication capability of the UE other than the communication capability that is currently used to transmit the non-AI model, or the remaining communication capability of the maximum amount of communication capability of the UE that is allocated to transmit the AI model other than the communication capability that has been used and/or reserved.

The battery level is the battery level of the UE, and is the battery level available for the AI model to run. In some embodiments, the battery level is represented by the remaining battery level. In some embodiments, the battery level is categorized into a total battery level and an AI battery level. The total battery level refers to the total battery level of the UE. The AI battery level refers to the battery level of the UE to run the AI model. In some embodiments, the AI battery level is the battery level of the UE to run the AI model, or the battery level of the total battery level of the UE that is maximally allocated or is currently allowed to be allocated to run the AI model, or the remaining battery level of the total battery level of the UE other than the battery level that has been used or is to be used to run the non-AI model application, or the remaining battery level of the maximum amount of battery level of the UE that is allocated to run the AI model other than the battery level that has been used and/or reserved.

The AI model index, also referred to as an AI model identification, is for indicating the AI model. Schematically, the AI model index is for indicating an AI model selected by the UE or an AI model supported by the UE based on the current UE capability.

In some embodiments, prior to reporting the AI model index selected by the UE itself to the network device, the UE needs to acquire information of at least one AI model. The information of the AI model includes at least one of the AI model index, the use case corresponding to the AI model, the AI model size, the AI model accuracy, the AI model complexity, or the generalization capability of the AI model. In some embodiments, the information of the at least one AI model is predefined by a communication protocol, or transmitted by the network device to the UE over an RRC message, or transmitted by the network device to the UE over a NAS layer message, or transmitted by the network device to the UE over a system broadcast, or transmitted over the NAS layer in the UE to the AS.

In some embodiments, the UE capability reporting further includes a granularity supported by the UE capability, such as per band, per terminal, per UE, different cases of FDD/TDD, and different cases of FR1/FR2. AI-related capability reporting is tied to the associated use case, e.g., the IE in the BFR capability reporting includes the capability information for AI BFR, which includes at least one of support or non-support of AI-enabled BFR indicated by one bit, and/or at least one of the functional capabilities described above, and/or at least one of the hardware capabilities described above.

In some embodiments, the UE reports the selected or supported AI model index. In some embodiments, the AI model index is an AI model index supported by the current UE capability, or an AI model index selected by the UE based on the current UE capability. The network device configures the first model set for the UE upon receiving the UE capability reported by the UE. The UE capability includes a static capability and a dynamic capability, wherein the static capability refers to a capability of the UE that does not vary dynamically, such as a battery capacity, a storage specification, a CPU performance, and the like. The dynamic capability refers to a capability of the UE that varies dynamically, including a UE capability that varies dynamically with at least one of a load of a processor, a remaining storage capability of a memory, a communication bandwidth capability, or a battery level. The first model set includes N AI models, and the N AI models all match the static capability of the UE. The network device determines the first model set that can be used by the UE based on the received static capability. Further, the network device or the UE determines, based on the dynamic capabilities of the UE, an AI model that the is currently used or supported by UE among the N AI models. Further, in the case that the UE determines the currently supported AI model among the N AI models based on the dynamic capability of the UE, the UE also reports the AI model index supported by the current UE capability to the network device, such that the network device switches to the AI model corresponding to the AI model index. Alternatively, in the case that the network device determines the AI model currently supported by the UE among the N AI models based on the dynamic capability, the network device configures the AI model index supported by the current UE capability for the UE, such that the UE switches to the AI model corresponding to the AI model index.

Exemplarily, the N AI models in the first model set configured by the network device for the UE are associated with different levels of UE capability, such as different levels of computing capability, different levels of storage capability, different levels of battery level, different levels of communication capability, and the like. The UE uses the AI model-based BM function, and in the case that the battery level decreases, the UE autonomously switches to the AI model that matches the current battery level and reports the currently supported AI model index to the network device. Alternatively, the UE uses the AI model-based BM function, and the UE reports the UE capability to the network device in the case that the above reporting conditions are satisfied. The network device determines the AI model currently supported by the UE based on the current UE capability, and configures an index of the AI model for the UE, such that the UE switches to the corresponding AI model based on the AI model index configured by the network device.

In some embodiments, the UE capability reporting includes a reporting time. In some embodiments, the reporting time includes a current time, and/or a serial number of the frame structure in which the current time is located. In some embodiments, the UE capability reporting further includes a time difference between the current time and the time of the previous reporting.

In some embodiments, the UE capability reporting includes a reporting position. In some embodiments, the reporting position includes an absolute position and/or a relative position. The absolute position is a latitude and longitude position where the UE is currently located. The relative position is an offset value of the current position of the UE relative to the position of the previous reporting or a reference position. In some embodiments, the reference position is predefined by a communication protocol, or configured by a network device, or determined autonomously by the UE. Exemplarily, the reference position is a position of a base station. In some embodiments, the UE capability reporting further includes a distance between the current position and the position of the previous reporting.

In some embodiments, the UE capability reporting includes a cell identifier of a service cell and/or a handover quantity of service cells. The cell identifier of the service cell is for indicating the service cell currently used by the UE to the network device, and the handover quantity of the service cells is for indicating the quantity of switching the service cells by the UE between the current reporting environment and the previous reporting environment to the network device. Exemplarily, the UE capability reporting includes information indicating that the current service cell of the UE is the cell A. Exemplarily, the UE capability reporting includes information indicating that the UE switches the service cells for two times between the current time and the time of the previous reporting.

In some embodiments, the UE capability reporting includes a variation of the current UE capability relative to the previously reported UE capability. Exemplarily, the variation of the UE capability includes at least one of:
a variation of the current AI computing capability relative to the previously reported AI computing capability;
a variation of the current AI storage capability relative to the previously reported AI storage capability;
a variation of the current AI communication capability relative to the previously reported AI communication capability;
a variation of the current AI battery level relative to the previously reported AI battery level;
a time difference between the current time relative to the previously reported time;
a distance between the current position relative to the previously reported position; or
a handover quantity of service cells between the current reporting environment and the previous reporting environment.

In some embodiments, the above variation is indicated using an explicit indication, or a bitmap indication, or a variation level.

In some embodiments, the UE capability reporting is reporting of the capability of each supported AI function use case, or the capability of a single AI function use case, or the total capability of the supported AI functions. The variation of the capability determined by the UE is a variation of the total capability of the AI functions, or a variation of the capability of a single AI function use case, or a variation of the capability of each AI function use case. That is, the granularity of the above UE capability reporting is at least one of: the granularity of a total capability, the granularity of a total AI capability, or the granularity of an AI capability of a single AI function use case. The determining granularity of the above UE capability variation is at least one of: the granularity of the total capability, the granularity of the total AI capability, or the granularity of the AI capability of the single AI function use case.

In some embodiments, the at least one capability in the reporting content is explicitly indicated, and/or the at least one capability is separately indicated using a capability level, and/or the at least two capabilities are indicated in combination using one capability level. In some embodiments, the capability level and/or the range corresponding to the capability level is predefined by the communication protocol or configured by the network device.

In some embodiments, the variation of the current UE capability in the reported content relative to the previously reported UE capability is explicitly indicated, and/or the variation of the at least one of the capabilities is separately indicated using a capability variation level, and/or the variation of the at least two capabilities is indicated in combination using one capability variation level. In some embodiments, the capability variation level and/or the range corresponding to the capability variation level is predefined by the communication protocol or configured by the network device. In some embodiments, the UE receives configuration information from the network device, and the configuration information is for configuring the reporting resource of the UE capability. In some embodiments, in the case that the reporting mode configured by the network device is satisfied, the UE reports the UE capability based on the reporting resources configured by the network device.

In some embodiments, the UE reports a supported AI model index to the network device.

In some embodiments, the UE autonomously switches to the AI model corresponding to the UE capability based on the current UE capability, or the UE switches to the AI model corresponding to the UE capability based on the configuration of the network device.

In some embodiments, the UE has at least two AI models, or model indexes of at least two AI models, or model parameters of at least two AI models. Based on the handover rule, the UE autonomously switches to the AI model corresponding to the UE capability. In some embodiments, the handover rule is predefined by a communication protocol, or configured by a network device, or autonomously determined by the UE. In some embodiments, the at least two AI models, or the model indexes of the at least two AI models, or the model parameters of the at least two AI models are locally stored by the UE or configured by the network device.

In some embodiments, the UE has at least two AI models, or model indexes of the at least two AI models, or model parameters of the at least two AI models. Based on the configuration of the network device, the UE switches to the AI model corresponding to the UE capability. In some embodiments, the at least two AI models or the model indexes of the at least two AI models or the model parameters of the at least two AI models are locally stored by the UE or configured by the network device.

In summary, in the method according to the embodiments of the present disclosure, the UE capability is reported to the network device based on the received configuration information of the network device, such that the flexibility and targeting of the UE capability reporting are improved.

The present disclosure provides an exemplary embodiment of UE capability reporting. Description is given in the embodiments based on an example in which the method is applicable to a UE.

The UE receives the periodic reporting mode from the network device, and the UE reports the UE capability to the network device. The periodic value is a fixed value, or a default value, or configured by the network device, or autonomously determined by the UE, or predefined by the communication protocol.

In some embodiments, the reporting mode transmitted by the network device indicates periodic reporting. In some embodiments, the reporting period is configured or indicated in the reporting mode transmitted by the network device.

In some embodiments, the UE reports a supported AI model index to the network device.

In some embodiments, the UE autonomously switches to the AI model corresponding to the UE capability based on the current UE capability, or the UE switches to the AI model corresponding to the UE capability based on the configuration of the network device.

In some embodiments, the UE has at least two AI models, or model indexes of at least two AI models, or model parameters of at least two AI models. Based on the handover rule, the UE autonomously switches to the AI model corresponding to the UE capability. In some embodiments, the handover rule is predefined by a communication protocol, or configured by a network device, or autonomously determined by the UE. In some embodiments, the at least two AI models, or the model indexes of the at least two AI models, or the model parameters of the at least two AI models are locally stored by the UE or configured by the network device.

In some embodiments, the UE has at least two AI models, or model indexes of the at least two AI models, or model parameters of the at least two AI models. Based on the configuration of the network device, the UE switches to the AI model corresponding to the UE capability. In some embodiments, the at least two AI models or the model indexes of the at least two AI models or the model parameters of the at least two AI models are locally stored by the UE or configured by the network device.

In summary, in the method according to the embodiments of the present disclosure, the UE reports the UE capability to the network device based on the received periodic reporting mode from the network device, such that the simplicity of the UE capability reporting is improved, and the loss of signaling resources in the process of the UE capability reporting is reduced in scenarios where the UE capability varies frequently or rapidly.

FIG. 5 illustrates a flowchart of a method for reporting the UE capability according to some embodiments of the present disclosure. Description is given in the embodiments based on an example in which the method is applicable to a UE. The method includes at least some of the following processes.

In 510, a reporting mode configured by the network device is received.

The UE receives a semi-persistent reporting mode configured by the network device. In some embodiments, the reporting mode is carried over the RRC message for transmission. In some embodiments, the reporting mode from the network device indicates semi-persistent periodic reporting. In some embodiments, the reporting mode from the network device indicates the semi-persistent period.

In some embodiments, prior to performing the process 510, the UE transmits a capability update reporting indication information to the network device, the capability update reporting indication information is for notifying the network device that the UE desires to update its own capability information.

In 530, activation signaling is received from the network device.

The UE receives the activation signaling from the network device, the activation signaling is for activating the UE to report the UE capability based on a semi-persistent period. The period value is a fixed value, or a default value, or configured by the network device, or determined autonomously by the UE, or predefined by the communication protocol.

In some embodiments, process 510 and process 530 may be combined. Alternatively, the activation signaling from the network device explicitly or implicitly indicates the semi-persistent reporting mode. In some embodiments, a semi-persistent period is configured or indicated in the activation signaling.

In 550, reporting the UE capability to the network device based on the semi-persistent period is started/activated.

Based on the semi-persistent reporting mode configured by the network device, the UE starts/activates reporting the UE capability to the network device based on the semi-persistent period in the case that the activation signaling is received from the network device. In some embodiments, the UE capability is carried over an RRC message or a MAC CE message or a UCI message to be reported to the network device.

In some embodiments, the UE receives configuration information from the network device, and the configuration information is for configuring the reporting resources of the UE capability. In some embodiments, in the case that the semi-persistent reporting mode configured by the network device is satisfied, the UE performs semi-persistent reporting the UE capability based on the semi-persistent reporting resources configured by the network device.

In 570, the deactivation signaling is received from the network device.

In some embodiments, in the case that the UE reports the UE capability to the network de vice, the UE receives the deactivation signaling from the network device. The deactivation signaling is for deactivating the UE to report the UE capability based on the semi-persistent period, i.e., the UE stops reporting the UE capability based on the semi-persistent period.

In some embodiments, the process 570 is an optional process.

In some embodiments, the UE reports a supported AI model index to the network device.

In some embodiments, the UE autonomously switches to the AI model corresponding to the UE capability based on the current UE capability, or the UE switches to the AI model corresponding to the UE capability based on the configuration of the network device.

In some embodiments, the UE has at least two AI models, or model indexes of at least two AI models, or model parameters of at least two AI models. Based on the handover rule, the UE autonomously switches to the AI model corresponding to the UE capability. In some embodiments, the handover rule is predefined by a communication protocol, configured by a network device, or autonomously determined by the UE. In some embodiments, the at least two AI models, or the model indexes of the at least two AI models, or the model parameters of the at least two AI models are locally stored by the UE or configured by the network device.

In some embodiments, the UE has at least two AI models, or model indexes of the at least two AI models, or model parameters of the at least two AI models. Based on the configuration of the network device, the UE switches to the AI model corresponding to the UE capability. In some embodiments, the at least two AI models, or the model indexes of the at least two AI models, or the model parameters of the at least two AI models are locally stored by the UE or configured by the network device.

In summary, in the method according to the embodiments of the present disclosure, the UE reports or stops reporting the UE capability to the network device based on the received semi-persistent reporting mode from the network device and the activation signaling and/or deactivation signaling, such that the flexibility and targeting of the UE capability reporting is improved.

FIG. 6 illustrates a flowchart of a method for reporting the UE capability according to some embodiments of the present disclosure. Description is given in the embodiments based on an example in which the method is applicable to a UE. The method includes at least some of the following processes.

In 610, the reporting mode configured by the network device is received.

The UE receives the aperiodic reporting mode configured by the network device. In some embodiments, the reporting mode is carried over the RRC message for transmission.

In some embodiments, prior to performing the process 610, the UE transmits the capability update reporting indication information to the network device. The capability update reporting indication information is for notifying the network device that the UE desires to update its own capability information.

In 630, trigger signaling is received from the network device.

The UE receives the trigger instruction from the network device, wherein the trigger instruction is for triggering the UE to report the UE capability.

In some embodiments, the processes 610 and 630 are combined. Alternatively, the trigger signaling from the network device explicitly or implicitly indicates the aperiodic reporting mode. In 650, the UE capability is reported to the network device.

Based on the aperiodic reporting mode configured by the network device, the UE reports the UE capability to the network device in case that the trigger signaling is received from the network device. In some embodiments, the UE capability is carried over an RRC message, or a MAC CE message, or a UCI message to be reported to the network device.

In some embodiments, the UE receives the configuration information from the network device, the configuration information is for configuring the reporting resource of the UE capability. In some embodiments, in the case that the aperiodic reporting mode configured by the network device is satisfied, the UE performs aperiodic reporting the UE capability based on the aperiodic reporting resources configured by the network device.

In some embodiments, the UE reports a supported AI model index to the network device.

In some embodiments, the UE autonomously switches to the AI model corresponding to the UE capability based on the current UE capability, or the UE switches to the AI model corresponding to the UE capability based on the configuration of the network device.

In some embodiments, the UE has at least two AI models, or model indexes of at least two AI models, or model parameters of at least two AI models. Based on the handover rule, the UE autonomously switches to the AI model corresponding to the UE capability. In some embodiments, the handover rule is predefined by a communication protocol, or configured by a network device, or autonomously determined by the UE. In some embodiments, the at least two AI models, or the model indexes of the at least two AI models, or the model parameters of the at least two AI models are locally stored by the UE or configured by the network device.

In some embodiments, the UE has at least two AI models, or model indexes of the at least two AI models, or model parameters of the at least two AI models. Based on the configuration of the network device, the UE switches to the AI model corresponding to the UE capability. In some embodiments, the at least two AI models or the model indexes of the at least two AI models or the model parameters of the at least two AI models are locally stored by the UE or configured by the network device.

In summary, in the method according to the embodiments of the present disclosure, the UE reports the UE capability to the network device based on the received aperiodic reporting mode from the network device and the trigger signaling, such that the resource loss of the UE capability reporting is reduced and the flexibility of the UE capability reporting is improved.

The present disclosure provides an exemplary embodiment of UE capability reporting. Description is given in the embodiments based on an example in which the method is applicable to a network device.

The network device transmits the configuration information to the UE, wherein the configuration information is related to UE capability reporting. In some embodiments, the configuration information includes at least one of: a reporting condition, a reporting mode, or a reporting resource.

Exemplarily, the network device configures the reporting condition, and/or the reporting mode, and/or the reporting resource to the UE.

In some embodiments, the network device configures the reporting condition for the UE, wherein the reporting condition includes at least one of the above described reporting conditions.

In some embodiments, the network device receives the UE capability reported by the UE, the UE capability is reported by the UE in the case that the reporting condition is satisfied. In some embodiments, the UE capability is carried over an RRC message, a MAC CE message, or a UCI message.

In some embodiments, the reporting mode configured by the network device for the UE includes at least one of: periodic reporting; semi-persistent reporting; or aperiodic reporting.

In some embodiments, the reporting mode transmitted by the network device to the UE indicates the periodic reporting. In some embodiments, the reporting mode is carried over the RRC message for transmission. In some embodiments, a reporting period is configured or indicated in the reporting mode transmitted by the network device.

In some embodiments, the network device receives the UE capability reported by the UE, and the UE capability is reported by the UE in the reporting mode configured by the network device. In some embodiments, the UE capability is carried over an RRC message, a MAC CE message, or a UCI message.

In some embodiments, the reporting mode transmitted by the network device to the UE indicates semi-persistent periodic reporting. In some embodiments, the reporting mode is carried over the RRC message for transmission. In some embodiments, a semi-persistent period is configured or indicated in the reporting mode transmitted by the network device.

In some embodiments, the network device transmits the activation signaling to the UE, and the activation signaling is for activating the UE to report the UE capability based on a semi-persistent period.

In some embodiments, the network device transmits the reporting mode and the activation signaling in combination, or the activation signaling explicitly or implicitly indicates the semi-persistent reporting mode. In some embodiments, the semi-persistent period is configured or indicated in the activation signaling.

In some embodiments, the network device receives the UE capability reported by the UE, wherein the UE capability is reported by the UE based on the reporting mode configured by the network device in which the UE start/activate the semi-persistent periodic reporting in the case that the activation signaling is received. In some embodiments, the UE capability is carried over an RRC message, a MAC CE message, or a UCI message.

In some embodiments, the network device transmits deactivation signaling to the UE, wherein the deactivation signaling is for deactivating the UE to reporting the UE capability based on the semi-persistent period, i.e. the UE stops reporting the UE capability based on the semi-persistent period.

In some embodiments, the reporting mode transmitted by the network device to the UE indicates the aperiodic reporting. In some embodiments, the reporting mode is carried over the RRC message for transmission.

In some embodiments, the network device transmits trigger signaling to the UE, wherein the trigger signaling is for triggering the UE to report the UE capability.

In some embodiments, the network device transmits the reporting mode and the trigger signaling in combination, or the trigger signaling explicitly or implicitly indicates the aperiodic reporting mode.

In some embodiments, the network device receives the UE capability reported by the UE, and the UE capability is reported by the UE to the network device based on the reporting mode configured by the network device in the case that the trigger signaling is received. In some embodiments, the UE capability is carried over an RRC message, a MAC CE message, or a UCI message.

In some embodiments, the UE capability reported by the UE received by the network device includes at least one of: a total capability, e.g., whether the UE supports the AI function; a supported AI function-based use case; a supported AI category level; a computing capability; a storage capability; a communication capability; a battery level; or an AI model index.

Among the above UE capability, the total capability, the use cases based on the AI function, and the supported AI category level are referred to as functional capabilities. The computing capability, storage capability, communication capability, and battery level are referred to as terminal hardware capabilities.

The AI function-based use case refers to a communication use case that is optimized based on the AI model. In some embodiments, the AI function-based use case includes at least one of AI-based positioning, AI-based beam management, AI-based channel state, user plane function information reporting in the air interface resources, and control plane function information reporting in the air interface resources. For example, the supported the AI function-based use case refers to supporting at least one of the AI-based positioning, the AI-based beam management, or the AI-based channel state information reporting. Alternatively, the supported AI function-based use case is at least one of all functions included in the user plane and the control plane in the air interface resource, e.g., at least one of: handover, cell selection/reselection, measurement, random access process, and resource allocation.

The supported AI category level refers to a supported AI function category based on the AI model. In some embodiments, the AI category level includes at least one of whether to support training, inference, or data collection on the terminal side. For example, the supported AI category level includes at least one of whether the UE supports training of the AI model on the terminal side, whether the UE supports inference of the AI model on the terminal side, and whether the UE supports data collection of the AI model on the terminal side.

The computing capability, also referred to as computing power, refers to the computing capability of the UE in running program tasks. In some embodiments, the computing capability is represented by at least one of a floating point computing capability per unit time, the number of GPUs, or a GPU cache size. In some embodiments, the computing capability is categorized into total computing capability and AI computing capability. The total computing capability, i.e., the total computing power, refers to the overall computing capability of the UE. The AI computing capability refers to the computing capability of the UE to run the AI model, which may reflect the complexity of the AI model supported by the UE. In some embodiments, the AI computing capability is the computing capability provided by the UE to run the AI model, or the computing capability of the total computing capability of the UE that is maximally allocated or is currently allowed to be allocated to run the AI model, or the remaining computing capability of the total computing capability of the UE other than the computing capability used to run the computation of the non-AI model, or the remaining computing capability of the maximum amount of computing capability of the UE that is allocated to run the AI model other than the computing capability that has been used and/or reserved.

The storage capability is the capability of the UE to store data. In some embodiments, the storage capability is represented by at least one of an available memory size, an available cache size, and an available storage size. In some embodiments, the storage capability is categorized into a total storage capability and an AI storage capability. The total storage capability refers to the storage capability of the UE to store all the data. The AI storage capability refers to the storage capability of the UE to store and/or run the AI model. In some embodiments, the AI storage capability is the storage capability provided by the UE to store and/or run the AI model, or the storage capability of the total storage capability of the UE that is maximally allocated or currently allowed to be allocated to store and/or run the AI model, or the remaining storage capability of the total storage capability of the UE other than the storage capability used for storing the non-AI model that is running, or the remaining storage capability of the maximum amount of storage capability of the UE that is allocated for storing the AI model other than the storage capability that has been used and/or reserved. Schematically, the AI storage capability is further categorized into a static storage capability, such as a flash memory capability, for storing the AI model and data related to the AI model; and a dynamic storage capability, such as a memory capability, for storing running data of the AI model.

The communication capability, also referred to as transmission capability, is the capability of the UE to communicate or transmit data, including at least one of bandwidth, rate, and delay. In some embodiments, the communication capability is represented by at least one of a supportable transmission rate, a transmission delay, a communication signal strength, channel quality state information, a transmission bit error rate, a transmission misinformation block rate, and a spectrum efficiency. In some embodiments, the communication capability is categorized into a total communication capability and an AI communication capability. The total communication capability refers to the overall communication capability of the UE. The AI communication capability refers to the capability of the UE to transmit the AI model and/or related data of the AI model. The related data includes training samples, model architecture, model parameters, and the like. In some embodiments, the AI communication capability is the communication capability that provided by the UE to transmit the AI model, or the communication capability of the total communication capability of the UE that is maximally allocated or currently allowed to be allocated to transmit the AI model, or the remaining communication capability of the total communication capability of the UE other than the communication capability that is currently used to transmit the non-AI model, or the remaining communication capability of the maximum amount of communication capability of the UE that is allocated to transmit the AI model other than the communication capability that has been used and/or reserved.

The battery level is the battery level of the UE, and is the battery level available for the AI model to run. In some embodiments, the battery level is represented by the remaining battery level. In some embodiments, the battery level is categorized into total battery level and AI battery level. The total battery level refers to the total battery level of the UE. The AI battery level refers to the battery level that is used by the UE to run the AI model. In some embodiments, the AI battery level is the battery level provided by the UE to run the AI model, or the battery level of the total battery level of the UE that is maximally allocated or is currently allowed to be allocated to run the AI model, or the remaining battery level of the total battery level of the UE other than the battery level that has been used for or to be used to run the non-AI model application, or the remaining battery level of the maximum amount of battery level of the UE that is allocated to run the AI model other than the battery level that has been used and/or reserved.

The AI model index, also referred to as an AI model identification, is for indicating the AI model. Schematically, the AI model index is for indicating an AI model selected by the UE or an AI model supported by the UE based on the current UE capability.

In some embodiments, prior to reporting the AI model index selected by the UE itself to the network device, the UE needs to acquire information of at least one AI model. The information of the AI model includes at least one of the AI model index, the use case corresponding to the AI model, the AI model size, the AI model accuracy, the AI model complexity, and the generalization capability of the AI model. In some embodiments, the information of the at least one AI model is predefined by a communication protocol, or transmitted by the network device to the UE over an RRC message, or transmitted by the network device to the UE over a NAS layer message, or transmitted by the network device to the UE over a system broadcast, or transmitted over the NAS layer in the UE to the AS.

In some embodiments, the UE capability reporting further includes a granularity supported by the UE capability, such as per band, per terminal, per UE, different cases of FDD/TDD, and different cases of FR1/FR2. AI-related capability reporting is tied to the associated use case, e.g., the IE in the BFR capability reporting includes the capability information for AI BFR, which includes at least one of 1 bit indicating support or non-support of AI-enabled BFR indicated by one bit, and/or at least one of the functional capabilities described above, and/or at least one of the hardware capabilities described above.

In some embodiments, the UE reports the selected or supported AI model index. In some embodiments, the AI model index is an AI model index supported by the current UE capability, or an AI model index selected by the UE based on the current UE capability. The network device configures the first model set for the UE upon receiving the UE capability reported by the UE. The UE capability includes a static capability and a dynamic capability, wherein the static capability refers to a capability of the UE that does not vary dynamically, such as a battery capacity, a storage specification, a CPU performance, and the like. The dynamic capability refers to a capability of the UE that varies dynamically, including a UE capability that varies dynamically with at least one of a load of a processor, a remaining storage capability of a memory, a communication bandwidth capability, and a battery level. The first model set includes N AI models, and the N AI models all match the static capability of the UE. The network device determines the first model set that can be used by the UE based on the received static capability. Further, the network device or the UE determines, based on the dynamic capabilities of the UE, an AI model that the is currently used or supported by UE among the N AI models. Further, in the case that the UE determines the currently supported AI model among the N AI models based on the dynamic capability of the UE, the UE also reports the AI model index supported by the current UE capability to the network device, such that the network device switches to the AI model corresponding to the AI model index. Alternatively, in the case that the network device determines the AI model currently supported by the UE among the N AI models based on the dynamic capability, the network device configures the AI model index supported by the current UE capability for the UE, such that the UE switches to the AI model corresponding to the AI model index.

Exemplarily, the N AI models in the first model set configured by the network device for the UE are associated with different levels of UE capability, such as different levels of computing capability, different levels of storage capability, different levels of battery level, different levels of communication capability, and the like. The UE uses the AI model-based BM function, and in the case that the battery level decreases, the UE autonomously switches to the AI model that matches the current battery level and reports the currently supported AI model index to the network device. Alternatively, the UE uses the AI model-based BM function, and the UE reports the UE capability to the network device in the case that the above reporting conditions are satisfied. The network device determines the AI model currently supported by the UE based on the current UE capability, and configures a model index of the AI model for the UE, such that the UE switches to the corresponding AI model based on the AI model index configured by the network device.

In some embodiments, the UE capability reporting includes a reporting time. In some embodiments, the reporting time includes a current time, and/or a serial number of the frame structure in which the current time is located. In some embodiments, the UE capability reporting further includes a time difference between the current time and the time of the previous reporting.

In some embodiments, the UE capability reporting includes a reporting position. In some embodiments, the reporting position includes an absolute position and/or a relative position. The absolute position is a latitude and longitude position where the UE is currently located. The relative position is an offset value of the current position of the UE relative to the position of the previous reporting or a reference position. In some embodiments, the reference position is predefined by a communication protocol, or configured by a network device, or determined autonomously by the UE. Exemplarily, the reference position is a position of a base station. In some embodiments, the UE capability reporting further includes a distance between the current position and the position of the previous reporting.

In some embodiments, the UE capability reporting includes a cell identifier of a service cell and/or a handover quantity of service cells. The cell identifier of the service cell is for indicating the service cell currently used by the UE to the network device, and the handover quantity of the service cells is for indicating the quantity of switching the service cells by the UE between the current reporting environment and the previous reporting environment to the network device. Exemplarily, the UE capability reporting includes information indicating that the current service cell of the UE is the cell A. Exemplarily, the UE capability reporting includes information indicating that the UE switches the service cells for two times between the current time and the time of the previous reporting.

In some embodiments, the UE capability reporting includes a variation of the current UE capability relative to the previously reported UE capability. Exemplarily, the variation of the UE capability includes at least one of:
a variation of the current AI computing capability relative to the previously reported AI computing capability;
a variation of the current AI storage capability relative to the previously reported AI storage capability;
a variation of the current AI communication capability relative to the previously reported AI communication capability;
a variation of the current AI battery level relative to the previously reported AI battery level;
a time difference between the current time relative to the previously reported time;
a distance between the current position relative to the previously reported position; or
a handover quantity of service cells between the current reporting environment and the previous reporting environment.

In some embodiments, the above variation is indicated using an explicit indication, or a bitmap indication, or a variation level.

In some embodiments, the UE capability reporting is reporting of the capability of each supported AI function use case, or the capability of a single AI function use case, or the total capability of the supported AI functions. The variation of the capability determined by the UE is a variation of the total capability of the AI functions, or a variation of the capability of a single AI function use case, or a variation of the capability of each AI function use case. That is, the granularity of the above UE capability reporting is at least one of: the granularity of a total capability, the granularity of a total AI capability, or the granularity of an AI capability of a single AI function use case. The determining granularity of the above UE capability variation is at least one of: the granularity of the total capability, the granularity of the total AI capability granularity, or the granularity of the AI capability of the single AI function use case.

In some embodiments, the at least one capability in the reporting content is explicitly indicated, and/or the at least one capability is separately indicated using a capability level, and/or the at least two capabilities are indicated in combination using one capability level. In some embodiments, the capability level and/or the range corresponding to the capability level is predefined by the communication protocol or configured by the network device.

In some embodiments, the variation of the current UE capability in the reported content relative to the previously reported UE capability is explicitly indicated, and/or the variation of the at least one of the capabilities is separately indicated using a capability variation level, and/or the variation of the at least two capabilities is indicated in combination using one capability variation level. In some embodiments, the capability variation level and/or the range corresponding to the capability variation level is predefined by the communication protocol or configured by the network device.

In some embodiments, prior to configuring the reporting mode, the reporting condition, the activation signaling, or the trigger signaling by the network device for the UE, the network device receives the capability update reporting indication information from the UE, wherein the capability update reporting indication information is for notifying the network device that the UE desires to update its own capability information.

In some embodiments, the network device transmits the configuration information to the UE, wherein the configuration information is for configuring the reporting resource of the UE capability.

In some embodiments, the network device stores at least two AI models, or a model index of at least two AI models, or model parameters of at least two AI models.

In some embodiments, the network device switches to an AI model corresponding to the UE capability based on the received UE capability.

In summary, in the method according to the embodiments of the present disclosure, the UE reports the UE capability based on the configuration of the network device, such that the targeting of the UE capability reporting is improved, the requirement for the autonomous reporting capability of the UE is reduced, and the stability of the UE capability reporting in the communication system is improved.

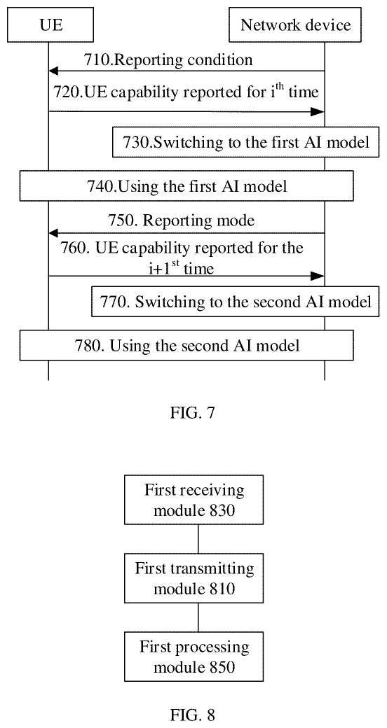

FIG. 7 illustrates the UE capability reporting according to some embodiments of the present disclosure. Description is given in the embodiments based on an example in which the method is applicable to a network device. The method includes at least some of the following processes.

In 710, the reporting condition is configured for the UE;

The network device configures the reporting condition for the UE, the reporting condition includes at least one of the above described reporting conditions, and/or starting/stopping the application, and/or the UE being in/out of a charging state. In some embodiments, the application program is predefined or configured by the network device.

In 720, the UE capability reported by the UE for i^{th} time is received.

The UE reports the UE capability to the network device in the case that the reporting condition is satisfied. Exemplarily, the UE capability is reported to the UE in the case that the UE capability satisfies the first condition, or a variation of the current reporting environment relative to the reporting environment of the previous reporting satisfies the second condition, or the UE stops the gaming application, or the UE enters the charging state.

In 730, the network device switches to the first AI model corresponding to the UE capability.

The network device switches to the first AI model corresponding to the UE capability based on the received UE capability.

In some implementations, the network device stores at least two AI models, or at least two AI model parameters, or at least two AI model indexes. Based on the received UE capability, the network device switches to the first AI model corresponding to the UE capability among the at least two AI models, or at least two AI model parameters, or at least two AI model indexes. In 740, a communication process is performed by using the first AI model.

The network device performs the communication process with the UE using the first AI model. Exemplarily, the UE reports the CSI to the network device using the first AI model.

In 750, the reporting mode is configured for the UE.

The network device configures a reporting mode for the UE. Exemplarily, the network device configures a periodic reporting mode for the UE, or the network device configures a semi-persistent periodic reporting mode for the UE, or the network device configures an aperiodic reporting mode for the UE.

In some embodiments, the network device configures a periodic reporting mode for the UE. In some embodiments, the configurated period is indicated in the reporting mode, the period being one hour.

In some embodiments, the network device configures a semi-persistent reporting mode for the UE. In some embodiments, a semi-persistent period is indicated in the reporting mode, the semi-persistent period being twenty minutes.

In some embodiments, the network device transmits activation signaling to the UE, wherein the activation signaling is for activating the UE to report the UE capability based on the semi-persistent period. Exemplarily, the network device transmits the semi-persistent reporting mode to the UE and activation signaling to the UE, wherein the activation signaling indicates that the semi-persistent period is ten minutes.

In some embodiments, the network device configures an aperiodic reporting mode for the UE.

In some embodiments, the network device transmits the trigger signaling to the UE, wherein the trigger signaling is for triggering the UE to report the UE capability. Exemplarily, the network device transmits the aperiodic reporting mode to the UE and transmits the trigger signaling to the UE.

In 760, the UE capability reported by the UE for the i+1^{st} time is received.

The network device receives the UE capability reported by the UE for the i+1^{st} time. The UE capability is reported by the UE to the network device based on the received reporting mode.

In 770, the network device switches to the second AI model corresponding to the UE capability.

The network device switches to the second AI model corresponding to the UE capability based on the received UE capability.

In some implementations, the network device stores at least two AI models, or at least two AI model parameters, or at least two AI model indexes. Based on the received UE capability, the network device switches to the second AI model corresponding to the UE capability in the at least two AI models, or at least two AI model parameters, or at least two AI model indexes.

In 780, the communication process is performed by the second AI model.

The network device performs the communication process with the UE using the second AI model. Exemplarily, the UE reports the CSI to the network device using the second AI model.

In some embodiments, the UE reports the UE capability to the network device in the case that at least one UE capability satisfies at least one of the above reporting conditions, or a plurality of capabilities satisfy the plurality of reporting conditions described above simultaneously.

It should be understood that the above UE capability reporting modes may be used in combination.

FIG. 8 illustrates a structural block diagram of an apparatus for reporting the UE capability according to some embodiments of the present disclosure. The apparatus includes at least some of the following modules.

The apparatus includes: a first transmitting module 810, configured to report the UE capability to a network device in the case that a reporting condition is satisfied.

In some embodiments, the first transmitting module 810 is further configured to report the UE capability to the network device in the case that the UE capability satisfies a first condition.

In some embodiments, the UE capability includes at least one capability. The first transmitting module 810 is further configured to report the UE capability to the network device in the case that at least one capability of the UE capability satisfies the first condition.

In some embodiments, the apparatus further includes a first receiving module 830.

The at least one capability is predefined, preconfigured, or configured by the network device for the first receiving module 830.

In some embodiments, the UE capability satisfying the first condition includes at least one of the following items: the UE capability is less than a first threshold; the UE capability is greater than a second threshold; or a variation of the UE capability relative to a previously reported UE capability is greater than a third threshold.

In some embodiments, the device further includes: a first receiving module 830. The first condition is predefined; or the first condition is preconfigured; or the first condition is configured by the network device for the first receiving module 830.

In some embodiments, the first transmitting module 810 is further configured to report the UE capability to the network device in the case that a variation of the current reporting environment relative to the reporting environment of a previous reporting satisfies the second condition.

In some embodiments, the variation of the current re reporting port environment relative to the reporting environment of the previous reporting satisfying the second condition includes the following items:
a duration between the current time and a time of the previous reporting is greater than a fourth threshold; and
a distance between the current position and a position of the previous reporting is greater than a fifth threshold.

In some embodiments, the apparatus further includes a first receiving module 830. The second condition is predefined; the second condition is preconfigured; or the second condition is configured by the network device to the first receiving module 830.

In some embodiments, the described device further includes: a first receiving module 830, configured to receive a reporting mode configured by the network device. The first transmitting module 810 is further configured to report the UE capability to the network device in the case that the reporting mode configured by the network device is satisfied.

In some embodiments, the reporting mode includes: periodic reporting; semi-persistent reporting; or aperiodic reporting.

In some embodiments, the reporting mode includes the semi-persistent reporting. The first receiving module 830 is further configured to receive activation signaling from the network device. The first transmitting module 810 is further configured to start/activate reporting the UE capability based on the semi-persistent period in the case that activation signaling is received from the network device. The first receiving module 830 is further configured to receive deactivation signaling from the network device. The first transmitting module 810 is further configured to stop/deactivate reporting the UE capability based on the semi-persistent period in the case that the deactivation signaling is received from the network device.

In some embodiments, the reporting mode includes the aperiodic reporting. The first receiving module 830 is further configured to receive trigger signaling from the network device. The first transmitting module 810 is further configured to report the UE capability in the case that the trigger signaling is received from the network device.

In some embodiments, the apparatus further includes: a first receiving module 830, configured to receive the configuration information from the network device, wherein the configuration information is for configuring reporting resource of the UE capability.

In some embodiments, the UE capability includes at least one of: whether to support an AI function; an AI function-based use case; a supported AI category level; a computing capability; a storage capability; a communication capability; or a battery level.

In some embodiments, at least one capability of the UE capability is explicitly indicated; and/or, at least one capability of the UE capability is separately indicated using a capability level; and/or at least two capabilities of the UE capability are indicated in combination using one capability level.

In some embodiments, the apparatus further includes: a first receiving module 830, configured to receive classification range of the capability level configured by a network device. The classification range of the capability level is configured by the network device for the first receiving module 830. Alternatively, the classification range of the capability level is defined by a communication protocol.

In some embodiments, the UE capability is carried in at least one of: a RRC message; a MAC CE message; or UCI.

In some embodiments, the first transmitting module 810 is further configured to report an AI model index supported by the UE.

In some embodiments, the apparatus further includes: a first processing module 850, configured to switch to an AI model corresponding to the UE capability.

In summary, in the apparatus according to the embodiments of present disclosure, by reporting the UE capability to the network device based on the dynamic variation of the UE capability, the network device is semi-statically instructed, and the autonomy, accuracy and flexibility of the UE capability reporting are improved.

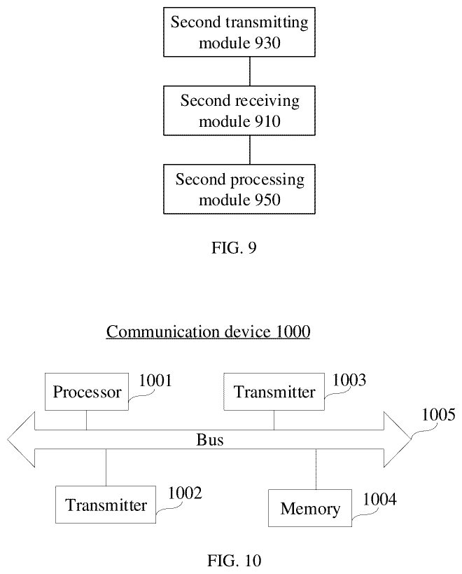

FIG. 9 illustrates a structural block diagram of an apparatus for reporting the UE capability according to some embodiments of the present disclosure. The apparatus includes at least some of the following modules.

The apparatus includes: a second receiving module 910, configured to receive the UE capability reported by a terminal, wherein the UE capability is reported by the terminal in the case that the reporting condition is satisfied.

In some embodiments, the UE capability is reported by the terminal in the case that the UE capability satisfies a first condition.

The device further includes: a second transmitting module 930, configured to configure the first condition for the terminal.

In some embodiments, a variation of the UE capability satisfying the first condition includes at least one of the following items: the UE capability is less than a first threshold; the UE capability is greater than a second threshold; or the variation of the UE capability relative to the previously reported UE capability is greater than a third threshold.

In some embodiments, the UE capability is reported by the terminal in the case that the variation of the current reporting environment relative to the reporting environment of the previous reporting satisfies the second condition.

The device further includes: a second transmitting module 930, configured to configure the second condition for the terminal.

In some embodiments, the variation of the current reporting environment relative to the reporting environment of the previous reporting satisfying the second condition includes the following items:
a duration between the current time and a time of the previous reporting is greater than a fourth threshold; and
a distance between the current position and a position of the previous reporting is greater than a fifth threshold.

In some embodiments, the device further includes: a second transmitting module 930, configured to configure a reporting mode of the UE capability for the terminal, wherein the UE capability is reported by the terminal based on the reporting mode configured by the second transmitting module 930.

In some embodiments, the reporting mode includes: periodic reporting; semi-persistent reporting; or aperiodic reporting.

In some embodiments, the reporting mode includes the semi-persistent reporting.

The second transmitting module 930 is further configured to transmit activation signaling to the terminal, wherein the activation signaling is for triggering the terminal to start/activate reporting the UE capability based on the semi-persistent period;

The second transmitting module 930 is further configured to transmit deactivation signaling to the terminal, wherein the deactivation signaling is for triggering the terminal to stop/deactivate reporting the UE capability based on the semi-persistent period.

In some embodiments, the reporting mode includes the aperiodic reporting.

The second transmitting module 930 is further configured to transmits trigger signaling to the terminal, wherein the trigger signaling is for triggering the terminal to report the UE capability.

In some embodiments, the apparatus further includes: a second transmitting module 930, configured to transmit the configuration information to the terminal, wherein the configuration information is for configuring a reporting resource of the UE capability.

In some embodiments, the UE capability includes at least one of: whether to support an AI function; an AI function-based use case; a supported AI category level; a computing capability; a storage capability; a communication capability; or a battery level.

In some embodiments, at least one capability of the UE capability is explicitly indicated; and/or, at least one capability of the UE capability is separately indicated using a capability level; and/or at least two capabilities of the UE capability are indicated in combination using one capability level.

In some embodiments, the apparatus further includes: a second transmitting module 930, configured to configure a classification range of the capability level for the UE.

In some embodiments, the UE capability is carried in at least one of: a RRC message; a MAC CE message; or UCI.

In some embodiments, the second receiving module 910 is further configured to receive a supported AI model index reported by the UE.

In some embodiments, the device further includes: a second processing module 950, configured to switch to an AI model corresponding to the UE capability.

In summary, in the apparatus provided by the embodiments of the present disclosure, the dynamic reporting of UE capability is received by configuring information for the UE, such that the efficiency, stability, accuracy, and flexibility of the UE capability reporting are improved.

It should be noted that, for the apparatus according to the embodiments described above, the division of the functional modules is merely exemplary. In practice, the functions described above may be assigned to and completed by different functional modules as needed, that is, an internal structure of the apparatus may be divided into different functional modules to implement all or some of the above functions.

With regard to the apparatus in the embodiments, specific manners in which modules perform operations have been described in detail in the embodiments of the related method, which are not described herein any further.

FIG. 10 illustrates a structural schematic diagram of a communication device (terminal device or network device) according to some embodiments of the present disclosure. The communication device 1000 includes: a processor 1001, a receiver 1002, a transmitter 1003, a memory 1004, and a bus 1005.

The processor 1001 includes one or more processing cores. The processor 1001 runs various functional applications and performs information processing by running software programs and modules.

The receiver 1002 and the transmitter 1003 may be implemented as a communication component. The communication component may be a communication chip.

The memory 1004 is connected to the processor 1001 via the bus 1005. The memory 1004 may be configured to store at least one instruction. The processor 1001, when loading and running the at least one instruction, is caused to perform the various processes in the above method embodiments.

In addition, the memory 1004 may be implemented using any type of volatile or non-volatile storage device or a combination thereof. The volatile or non-volatile storage devices include but is not limited to: a magnetic disk or optical disk, an electrically erasable programmable read only memory (EEPROM), an erasable programmable read-only memory (EPROM), a static random-access memory (SRAM), a read-only memory (ROM), a magnetic memory, a flash memory, or a programmable read-only memory (PROM).

In some embodiments, a computer-readable storage medium is further provided. The computer-readable storage medium stores at least one program. The at least one program, when loaded and run by a processor, causes the processor to perform the method for reporting the UE capability according to the above method embodiments.

In some embodiments, a chip is further provided. The chip includes at least one programmable logic circuitry and/or at least one program instruction. The chip, when running on a communication device, is caused to perform the method for reporting the UE capability according to the above method embodiments.

In some embodiments, a computer program product is further provided. The computer product, when running on a processor of a computer device, causes the computer device to perform the above method for reporting the UE capability.

It should be understood by those skilled in the art that in one or more of the above embodiments, the function described in the embodiments of the present disclosure may be implemented by hardware, software, firmware, or any combination thereof. When implemented by software, the functions may be stored in a computer-readable medium or transmitted as one or more instructions or codes on a computer-readable medium. The computer-readable medium includes a computer storage medium and a communication medium. The communication medium includes any medium that facilitates the transfer of a computer program from one location to another. The storage medium may be any available medium that is accessible by a general-purpose or special-purpose computer.

Described above are merely embodiments of the present disclosure and are not intended to limit the present disclosure. Any modification, equivalent replacement, and improvement, and the like, made within the spirit and principle of the present disclosure shall fall within the protection scope of the present disclosure.

1. A method for reporting a user equipment (UE) capability, comprising:
reporting the UE capability to a network device in a case that a reporting condition is satisfied.

2. The method according to claim 1, wherein reporting the UE capability to the network device in the case that the reporting condition is satisfied comprises one of:
reporting the UE capability to the network device in a case that the UE capability satisfies a first condition; or
reporting the UE capability to the network device in a case that a variation of a current reporting environment relative to a reporting environment of a previous reporting satisfies a second condition.

3. The method according to claim 2, wherein
the UE capability comprises at least one capability; and
reporting the UE capability to the network device in the case that the UE capability satisfies the first condition comprises:
reporting the UE capability to the network device in a case that at least one of the at least one capability of the UE capability satisfies the first condition;
wherein the at least one capability is predefined, or preconfigured, or configured by the network device.

4. The method according to claim 2, wherein the UE capability satisfying the first condition comprises at least one of:
the UE capability being less than a first threshold;
the UE capability being greater than a second threshold; or
a variation of the UE capability relative to a previously reported UE capability being greater than a third threshold.

5. The method according to claim 2, wherein
the first condition is predefined; the first condition is preconfigured; or the first condition is configured by the network device; or
the second condition is predefined; the second condition is preconfigured; or the second condition is configured by a network device.

6. The method according to claim 2, wherein the variation of the current reporting environment relative to the reporting environment of the previous reporting satisfying the second condition comprises:
a duration between a current time and a time of the previous reporting being greater than a fourth threshold; and
a distance between a current position and a position of the previous reporting being greater than a fifth threshold.

7. The method according to claim 1, wherein reporting the UE capability to the network device in the case that the reporting condition is satisfied comprises:
reporting the UE capability to the network device in a reporting mode configured by the network device;
wherein the reporting mode comprises: periodic reporting; semi-persistent reporting; or
aperiodic reporting.

8. The method according to claim 7, wherein
the reporting mode comprises the semi-persistent reporting;
reporting the UE capability to the network device based on the reporting mode configured by the network device comprises:
starting/activating reporting the UE capability based on a semi-persistent period in a case that activation signaling is received from the network device; and
the method further comprises:
stopping/deactivating reporting the UE capability based on the semi-persistent period in a case that deactivation signaling is received from the network device.

9. The method according to claim 7, wherein
the reporting manner comprises the aperiodic reporting; and
reporting the UE capability to the network device based on the reporting mode configured by the network device comprises:
reporting the UE capability to the network device in a case that a trigger signaling is received from the network device.

10. A terminal, comprising:
a processor;
a transceiver, communicably connected to the processor; and
a memory, configured to store one or more executable instructions of the processor;
wherein the processor is configured to load and execute the one or more executable instructions, to cause the terminal to perform:
reporting the UE capability to a network device in a case that a reporting condition is satisfied.

11. The terminal according to claim 10, wherein the processor is configured to load and execute the one or more executable instructions, to cause the terminal to further perform at least one of:
receiving configuration information from the network device, wherein the configuration information is for configuring a reporting resource of the UE capability;
reporting an AI model index supported by the UE; or
switching to an AI model corresponding to the UE capability.

12. The terminal according to claim 10, wherein the UE capability comprises at least one of:
whether to support an artificial intelligence (AI) function;
an AI function-based use case;
a supported AI category level;
a computing capability;
a storage capability;
a communication capability; or
a battery level.

13. The terminal according to claim 12, wherein there is at least one of:
at least one capability of the UE capability is explicitly indicated;
at least one capability of the UE capability is separately indicated using a capability level; or
at least two capabilities of the UE capability are indicated in combination using one capability level;
wherein a classification range of the capability level is configured by a network device, or a classification range of the capability level is defined by a communication protocol.

14. The terminal according to claim 10, wherein the UE capability is carried in at least one of:
a radio resource control (RRC) message;
a medium access control (MAC) control element (CE) message; or
uplink control information (UCI).

15. A network device, comprising:
a processor;
a transceiver, communicably connected to the processor; and
a memory, configured to store one or more executable instructions;
wherein the processor is configured to load and execute the one or more executable instructions, to cause the network device to perform:
receiving the UE capability reported by a terminal, wherein the UE capability is reported by the terminal in a case that a reporting condition is satisfied.

16. The network device according to claim 15, wherein there is one of:
the UE capability is reported by the terminal in a case that the UE capability satisfies a first condition; and the processor is configured to load and execute the one or more executable instructions, to cause the network device to further perform: configuring the first condition for the terminal;
the UE capability is reported by the terminal in a case that a variation of a current reporting environment relative to a reporting environment of a previous reporting satisfies a second condition; and the processor is configured to load and execute the one or more executable instructions, to cause the network device to further perform: configuring the second condition for the terminal; or
the UE capability is reported by the terminal in a reporting mode configured by the network device; and the processor is configured to load and execute the one or more executable instructions, to cause the network device to further perform: configuring the reporting mode of the UE capability for the terminal.

17. The network device according to claim 16, wherein the UE capability satisfying the first condition comprises at least one of:
the UE capability being less than a first threshold;
the UE capability being greater than a second threshold; or
a variation of the UE capability relative to a previously reported UE capability being greater than a third threshold.

18. The network device according to claim 16, wherein the variation of the current reporting environment relative to the reporting environment of the previous reporting satisfying the second condition comprises:
a duration between a current time and a time of the previous reporting being greater than a fourth threshold; and
a distance between a current position and a position of the previous reporting being greater than a fifth threshold.

19. The network device according to claim 16, wherein
the reporting mode comprises the semi-persistent reporting;
the processor is configured to load and execute the one or more executable instructions, to cause the network device to further perform:
transmitting an activation signaling to the terminal, wherein the activation signaling is for triggering the terminal to start/activate reporting the UE capability based on a semi-persistent period; and
the processor is configured to load and execute the one or more executable instructions, to cause the network device to further perform:
transmitting a deactivation signaling to the terminal, wherein the deactivation signaling is for triggering the terminal to stop/deactivate reporting the UE capability based on the semi-persistent period.

20. The network device according to claim 16, wherein
the reporting mode comprises the aperiodic reporting; and
the processor is configured to load and execute the one or more executable instructions, to cause the network device to further perform:
transmitting a trigger signaling to the terminal, wherein the trigger signaling is for triggering the terminal to report the UE capability.
